(19) United States
(12) Patent Application Publication
(10) Pub. No.: US 2025/0310478 A1
(43) Pub. Date: Oct. 2, 2025

(54) DUPLICATE IMAGE DETECTION FOR ELECTRONIC MEETINGS

(71) Applicant: Lenovo (Singapore) Pte. Ltd., Singapore (SG)

(72) Inventors: Lincoln Penn Hancock, Raleigh, NC (US); Ellis Anderson, Greensboro, NC (US); Jeffrey E. Skinner, Raleigh, NC (US)

(21) Appl. No.: 18/622,591

(22) Filed: Mar. 29, 2024

(51) Int. Cl. H04N 7/15; G01S 17/89; G06V 40/16

(52) U.S. Cl. CPC H04N 7/152; G01S 17/89; G06V 40/161

(57) ABSTRACT

A computer implemented method includes receiving an image of a meeting area from a first camera during an electronic conference call, detecting multiple faces in the image using a facial recognition model, receiving information from a secondary sensor to identify locations of participants in the meeting area, correlating the detected faces with the locations of participants, and generating a set of images of the participants that excludes detected faces that do not correspond to the locations of participants.

### BACKGROUND

Hybrid electronic meetings utilize one or more cameras in a meeting room to capture images of local participants for transmission to remote participants. The images may be analyzed to identify local participants and generate one or more frames showing the local participants in individual frames for a gallery view which may also include remote participants. A camera may also capture an image of a participant on a display or a reflection of a participant. Capturing the reflection can result in transmitting both the reflection in one frame and another frame containing a directly captured image of the same participant.

Transmitting the reflection may be referred to as an unintended broadcast. While some electronic meeting systems include features that allow identification of zones to ignore or allow restricting a field of view, such features may be ineffective in preventing transmission of reflections or scenarios where multiple “people screens” may be in use. At least one further meeting system allows users to specify a width and depth of the area in which individuals should be captured which may also be ineffective in preventing transmission of reflections or other “people screens” within the user-configured boundary zone.

### SUMMARY

A computer implemented method includes receiving an image of a meeting area from a first camera during an electronic conference call, detecting multiple faces in the image using a facial recognition model, receiving information from a secondary sensor to identify locations of participants in the meeting area, correlating the detected faces with the locations of participants, and generating a set of images of the participants that excludes detected faces that do not correspond to the locations of participants.

### BRIEF DESCRIPTION OF THE DRAWINGS

FIG. 1 is an overhead block representation of a meeting room having at least one camera and secondary sensor according to an example embodiment.

FIG. 2 is a block diagram of a meeting system for correlating local participant physical presence with images of participants according to an example embodiment.

FIG. 3 is a flowchart illustrating a computer implemented method of correlating local participant presence with images of participants according to an example embodiment.

FIG. 4 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Hybrid electronic meetings utilize one or more cameras in a meeting room to capture images of local participants for transmission to remote participants. The images may be analyzed by a meeting system to identify local participants and generate one or more frames showing the local participants in individual frames for a gallery view of local participants for transmission to remote participants. Prior meeting systems may also identify reflections of participants and generate a frame for each reflection, resulting in unintended broadcasting of the reflections. That can lead to display clutter, duplicate frames of participants, extra processing, and even reduction size of frames in the gallery view.

An improved hybrid electronic meeting system provides a method to distinguish real and intended participants in a meeting broadcast from reflections, screen-based images, and even non-participant persons that may be outside of a meeting area, such as in a background. A secondary sensor provides information used to verify the physical presence of people and ensures they are within a set range of a meeting camera, or that they are within a meeting room or area. Various secondary sensors may be used such as time-of-flight (ToF) sensors, PIR sensors or light detection and ranging (LIDAR)sensors.

The information collected by one or more of such secondary sensors is used to identify physical presence. Each identified physical presence is cross-referenced with people or faces identified from camera images in a scene. Faces that do not match are identified as not verified as physically-present by the secondary sensor and identified as extraneous faces. Extraneous faces are ignored while creating participant frames for transmission to remote participants.

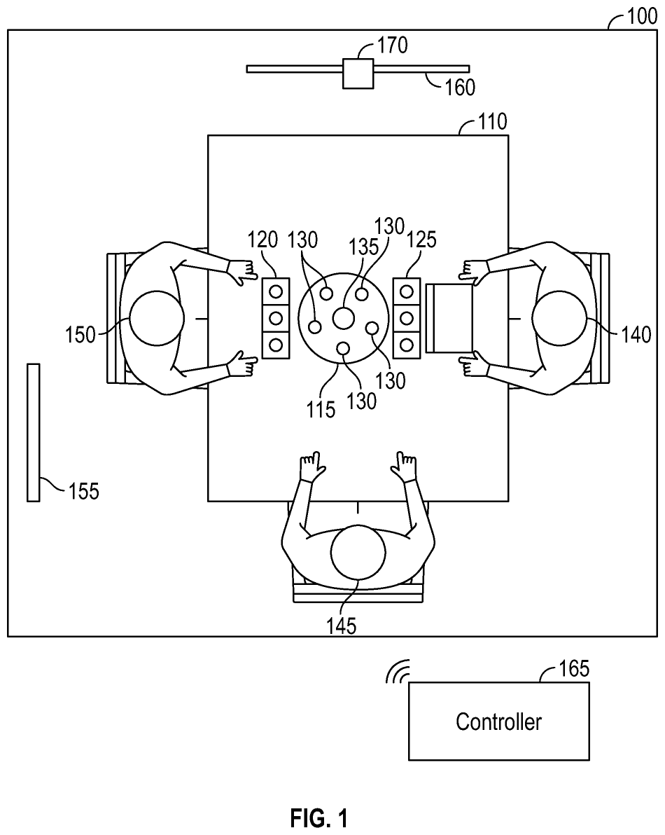

FIG. 1 is an overhead block representation of a meeting area 100 that includes a meeting table 110. The meeting area 100 may include walls or may even be an open space in various examples. A first device 115 is located near a middle of the table 110 and includes one or more displays 120 and 125 as well as a first camera 130. First camera 130 may include several cameras to capture view of the room including a 360-degree field of view. Displays 120 and 125 may contain gallery views that may include remote participants, and optionally local participants.

First device 115 may also include a secondary sensor 135 used to provide information from which a physical presence of a meeting participant can be identified. Example secondary sensors include time-of-flight (ToF) sensors, passive infrared (PIR) sensors, or light detection and ranging (LIDAR) sensors.

ToF sensors are devices that have found extensive applications across multiple sectors. ToF sensors calculate the distance between the sensor and an object, such as a face or body, based on the travel time of a light signal. ToF sensors are used for a range of applications, including robot navigation, vehicle monitoring, people counting, and object detection. When an image of a participant has no depth, the image is likely captured from a reflective surface or display and may be characterized as an extraneous image based on the lack of depth. Since a reflective surface or display is usually fairly flat, the depth may be the same if the sensor is located orthogonal to the surface. If not, the depth may vary linearly or substantially linearly in the case of a curved display or surface, which is also characteristic of a reflection or display.

A PIR sensor is an electronic sensor that measures infrared light radiating from objects in its field of view. PIR sensors are commonly used in security alarms and automatic lighting applications. An image of a participant that emits a heat profile that is different from a known heat profile of a person, may be characterized as an extraneous image. A trained model may be used in one example to distinguish between information collected from a reflection or display and that obtained from a physically present person.

A lidar sensor is a remote sensing device that emits laser pulses to measure the distance to a target and then records the time it takes for the reflected light to return. The sensor calculates the distance each pulse travels by measuring how long it takes for the pulse to return. This process is repeated millions of times per second to create a real-time 3D map of the surrounding environment. When an image of a participant has no depth, the image is likely captured from a reflective surface or display and may be characterized as an extraneous image based on the lack of depth.

In one example, the camera 130 and secondary sensor 135 share a common field of view. The common field of view enables simple correlation of images of local participants 140, 145, and 150 situated around the table 110 with positions of physical persons determined from the information provided by the secondary sensor 135. While the camera may capture images of persons on a display or reflections of participants, such as off a mirror or screen 155 positioned off a side of the table 110, or even off of a display 160 positioned off a head of the table, such images are extraneous images. The secondary sensor provides information that is used by a meeting controller 165 to identify extraneous images. The meeting controller receives the identification of extraneous images and excludes them in the creation of a gallery view of actual physically present participants.

The meeting controller 165 may be remote from the first device 115 and connected via local area network or may be part of first device 115 in further examples. Meeting controller 165 may also receive images and secondary sensor information from a second device 170 located near or with display 160, which may also be connected to meeting controller 165. The camera and secondary sensor in second device 170 may provide further views of the meeting room for use in detecting and excluding extraneous images of participants.

Multiple additional cameras and secondary sensors may be utilized throughout the meeting area 100 and provide images and information to the meeting controller 165 for use in identifying and excluding extraneous images. The controller may also be configured to determine which image of an actually present participant to use in the gallery display by selecting from images of the participant that correspond to the same position in the meeting area 100 or utilizing forms of facial recognition, using an image with a highest confidence of a front view of a face of the participant.

In further examples, where at least one of the secondary sensors provide information regarding distance, such information may be used to identify physically present people who exceed a selected distance which is outside meeting area 100. This can be useful in examples where the meeting area is in an open floor plan space, or even an outdoor meeting. Physically present people who exceed the selected distance may be classified as extraneous images in the images generated by camera 130. Such extraneous images may also be excluded from the gallery view.

In one example, the secondary sensor 135 and camera 130 may be located very close together and have a substantially matching field of view. Angles of participants detected in images captured will then match or be very close to angles of physical presence detected by the secondary sensor. In examples where the respective fields of views are different, such fields of view may be resolved using a common coordinate system or the meeting area, such as the head of table being identified as zero degrees. Trigonometric functions may be used to correlate the images and secondary sensor information.

In a further example, the camera 130 itself may include a microbolometer array as the secondary sensor in addition to an image sensor array. The angles and positions of both participant images and physical presence detected will match very well, enabling a very simple correlation and exclusion of extraneous participant images. Even if the arrays are the same array, the information collected from such array or arrays is utilized to create both images of participants for the gallery view and information regarding actual physical presence for exclusion of extraneous images from the generated gallery display.

In one example, participant 140 may have a laptop device, which may be either displaying images of people, or reflecting images of participants. Such images may also be classified as extraneous images for generation of the gallery view. Similarly screen 155 may also be displaying images of people, which can be identified as extraneous images.

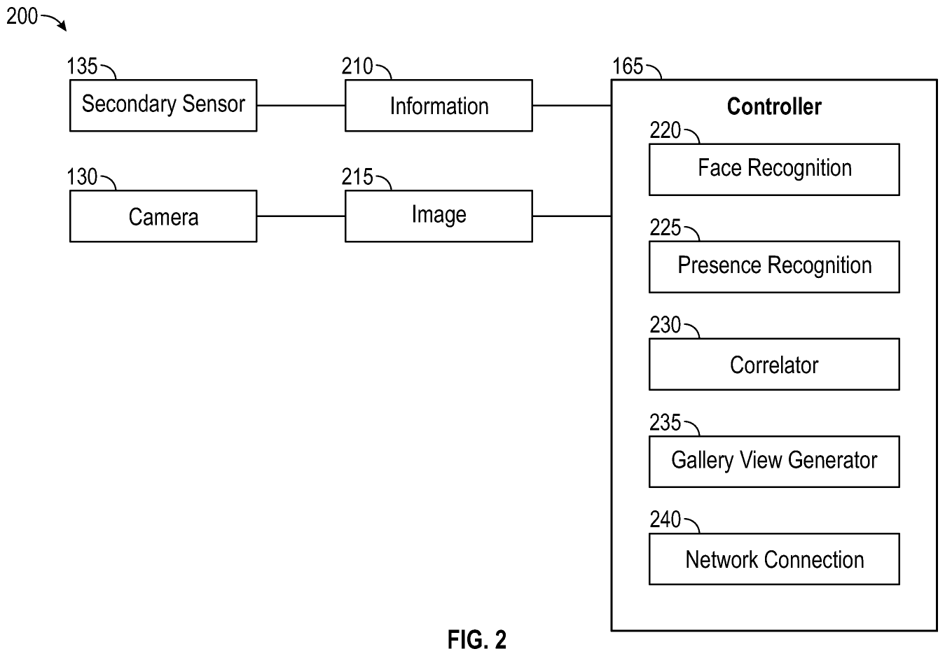

FIG. 2 is a block diagram of a meeting system 200 for correlating local participant physical presence with images of participants. System 200 includes camera 130, secondary sensor 135, and controller 165 which receives information 210 from secondary sensor 135 and image 215 from camera 130. Controller 165 provides the image 215 to a face recognition model 220 which identifies each image of a person. In one example, the face recognition model 220 creates a frame for each person identified along with a corresponding location or angle within a field of view of the camera 130.

The information 210 from secondary sensor 135 is provided to a presence recognition 225 function, which identifies the location of actual people within its field of view. The locations from the fact recognition model 220 and presence recognition 225 function are correlated at correlator 230. Images not correlated with a location of an identified actual person are identified at correlator 230. Only correlated images are provided to a gallery view generator 235 and stitched together into a gallery view. The gallery view may be broadcast or otherwise transmitted for display at network connection 240. The gallery view may be provided to displays within a meeting area and may also be transmitted to remote participant devices connected to a hybrid meeting.

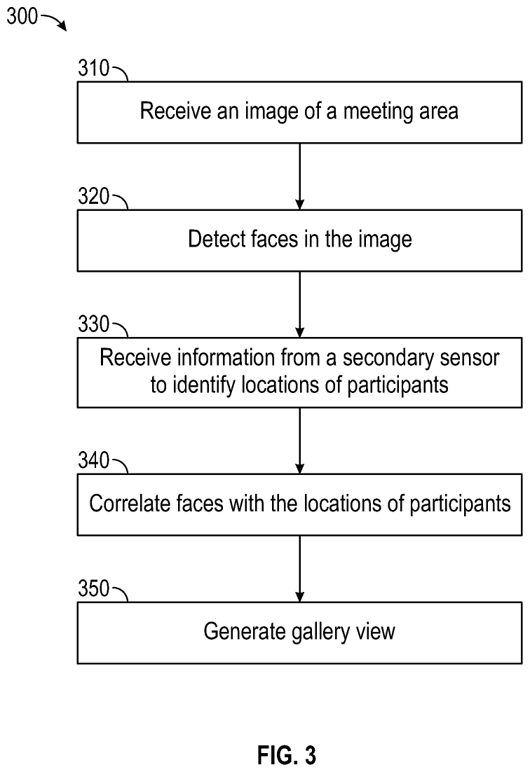

FIG. 3 is a flowchart illustrating a computer implemented method 300 of correlating local participant presence with images of participants. Method 300 begins at operation 310 by receiving an image of a meeting area from a first camera during an electronic conference call. Multiple faces in the image are detected at operation 320 by using a facial recognition model. Operation 330 receives information from a secondary sensor to identify locations of participants in the meeting area.

In one example, the secondary sensor is a distance sensor that provides information corresponding to depth measurements the participants, such as the faces of the participants. The distance sensor may be a light detection and ranging (LIDAR) sensor or a time-of-flight (ToF) sensor. In a further example, the secondary sensor is an infrared sensor and wherein the information corresponds to heat measurements of the person or the faces of the participants.

The detected faces are correlated at operation 340 with the locations of participants. A gallery view of the participants that excludes detected faces that do not correspond to the locations of participants is generated at operation 350. Detected faces having constant or linear depth measured by the distance sensor are identified as extraneous and are excluded from the gallery view. Detected faces having constant or linear heat measurements are identified as extraneous and are excluded from the gallery view. Detected faces having heat measurements not representative of a person are also identified as extraneous and are excluded from the gallery view.

In a further example, detected people who are outside of a selected distance or boundary from the distance sensor are excluded from the gallery view as such people may be deemed extraneous and not participants.

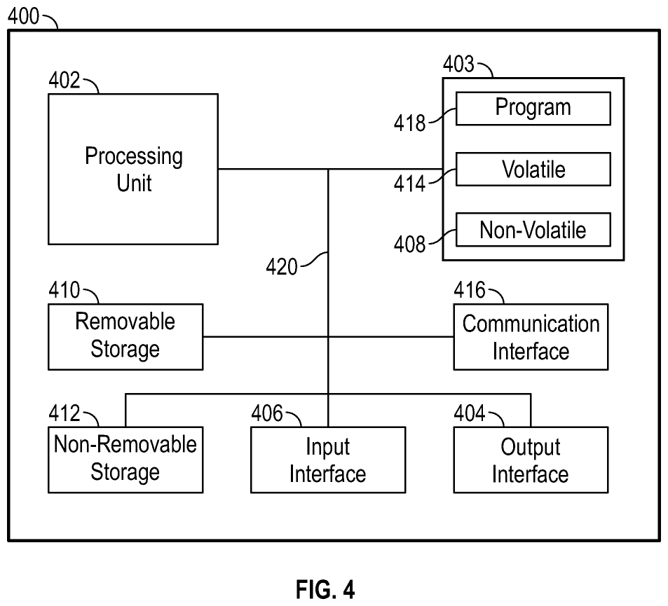

FIG. 4 is a block schematic diagram of a computer 400 to correlate physically present participants in a hybrid meeting for inclusion in a gallery view and for performing methods and algorithms according to example embodiments. All components need not be used in various embodiments.

One example computing device in the form of a computer 400 may include a processing unit 402, memory 403, removable storage 410, and non-removable storage 412. Although the example computing device is illustrated and described as computer 400, the computing device may be in different forms in different embodiments. For example, the computing device may instead be a smartphone, a tablet, smartwatch, smart storage device (SSD), or other computing device including the same or similar elements as illustrated and described with regard to FIG. 4. Devices, such as smartphones, tablets, and smartwatches, are generally collectively referred to as mobile devices or user equipment.

Although the various data storage elements are illustrated as part of the computer 400, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 400 may include or have access to a computing environment that includes input interface 406, output interface 404, and a communication interface 416. Output interface 404 may include a display device, such as a touchscreen, that also may serve as an input device. The input interface 406 may include one or more of a touchscreen, touchpad, mouse, keyboard, camera, one or more device-specific buttons, one or more sensors integrated within or coupled via wired or wireless data connections to the computer 400, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 400 are connected with a system bus 420.

Computer-readable instructions stored on a computer-readable medium are executable by the processing unit 402 of the computer 400, such as a program 418. The program 418 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 418 along with the workspace manager 422 may be used to cause processing unit 402 to perform one or more methods or algorithms described herein.

### EXAMPLES

1. A computer implemented method includes receiving an image of a meeting area from a first camera during an electronic conference call, detecting multiple faces in the image using a facial recognition model, receiving information from a secondary sensor to identify locations of participants in the meeting area, correlating the detected faces with the locations of participants, and generating a set of images of the participants that excludes detected faces hat do not correspond to the locations of participants.

2. The method of example 1 wherein the secondary sensor includes a distance sensor and wherein the information corresponds to depth measurements the participants.

3. The method of example 2 wherein the depth measurements are of the faces of the participants.

4. The method of example 3 wherein detected faces having constant or linear depth are excluded from the set of images.

5. The method of any of examples 2-4 wherein the distance sensor includes a light detection and ranging (LIDAR) sensor.

6. The method of any of examples 2-5 wherein the distance sensor includes a time-of-flight (ToF) sensor.

7. The method of any of examples 1-6 and further including transmitting the identified images to a remote participant device.

8. The method of any of examples 1-7 wherein the secondary sensor includes an infrared sensor and wherein the information corresponds to heat measurements of the participant.

9. The method of example 8 wherein heat measurements are of the faces of the participants.

10. The method of example 9 wherein detected faces having constant or linear heat measurements are excluded from the set of images.

11. The method of any of examples 9-10 wherein detected faces having heat measurements not representative of a person are excluded from the set of images.

12. A machine-readable storage device has instructions for execution by a processor of a machine to cause the processor to perform operations to perform any of the methods of examples 1-11.

13. A device includes a processor and a memory device coupled to the processor and having a program stored thereon for execution by the processor to perform operations to perform any of the methods of examples 1-11.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving an image of a meeting area from a first camera during an electronic conference call;
detecting multiple faces in the image using a facial recognition model;
receiving information from a secondary sensor to identify locations of participants in the meeting area;
correlating the detected faces with the locations of participants; and
generating a set of images of the participants that excludes detected faces that do not correspond to the locations of participants.

2. The method of claim 1 wherein the secondary sensor comprises a distance sensor and wherein the information corresponds to depth measurements the participants.

3. The method of claim 2 wherein the depth measurements are of the faces of the participants.

4. The method of claim 3 wherein detected faces having constant or linear depth are excluded from the set of images.

5. The method of claim 2 wherein the distance sensor comprises a light detection and ranging (LIDAR) sensor.

6. The method of claim 2 wherein the distance sensor comprises a time-of-flight (ToF) sensor.

7. The method of claim 1 and further comprising transmitting the identified images to a remote participant device.

8. The method of claim 1 wherein the secondary sensor comprises an infrared sensor and wherein the information corresponds to heat measurements of the participant.

9. The method of claim 8 wherein heat measurements are of the faces of the participants.

10. The method of claim 9 wherein detected faces having constant or linear heat measurements are excluded from the set of images.

11. The method of claim 9 wherein detected faces having heat measurements not representative of a person are excluded from the set of images.

12. A machine-readable storage device having instructions for execution by a processor of a machine to cause the processor to perform operations to perform a method, the operations comprising:
receiving an image of a meeting area from a first camera during an electronic conference call;
detecting multiple faces in the image using a facial recognition model;
receiving information from a secondary sensor to identify locations of participants in the meeting area;
correlating the detected faces with the locations of participants; and
generating a set of images of the participants that excludes detected faces that do not correspond to the locations of participants.

13. The device of claim 12 wherein the secondary sensor comprises a distance sensor and wherein the information corresponds to depth measurements the participants.

14. The device of claim 13 wherein the depth measurements are of the faces of the participants.

15. The device of claim 14 wherein detected faces having constant or linear depth are excluded from the set of images.

16. The device of claim 13 wherein the distance sensor comprises a light detection and ranging (LIDAR) sensor or a time-of-flight (ToF) sensor.

17. The device of claim 12 wherein the operations further comprise transmitting the identified images to a remote participant device.

18. The device of claim 12 wherein the secondary sensor comprises an infrared sensor and wherein the information corresponds to heat measurements of faces of the participant.

19. A device comprising:
a processor; and
a memory device coupled to the processor and having a program stored thereon for execution by the processor to perform operations comprising:
receiving an image of a meeting area from a first camera during an electronic conference call;
detecting multiple faces in the image using a facial recognition model;
receiving information from a secondary sensor to identify locations of participants in the meeting area;
correlating the detected faces with the locations of participants; and
generating a set of images of the participants that excludes detected faces that do not correspond to the locations of participants.

20. The device of claim 19 wherein the secondary sensor comprises a distance sensor, a light detection and ranging (LIDAR) sensor, or a time-of-flight (ToF) sensor and wherein the operations further comprise transmitting the identified images to a remote participant device.
